(19) United States
(12) Patent Application Publication
(10) Pub. No.: US 2024/0149722 A1
(43) Pub. Date: May 9, 2024

(54) HANDS FREE ELECTRIC VEHICLE CHARGING SYSTEM

(71) Applicant: EVJAM LLC, Minneapolis, MN (US)

(72) Inventors: Gregg KROMREY, Hudson, WI (US); Steven DICKE, Minneapolis, MN (US)

(73) Assignee: EVJAM LLC, Minneapolis, MN (US)

(21) Appl. No.: 18/387,452

(22) Filed: Nov. 6, 2023

Related U.S. Application Data
(60) Provisional application No. 63/422,684, filed on Nov. 4, 2022.

(51) Int. Cl. B60L 53/35; B60L 53/16; H02J 7/00

(52) U.S. Cl. CPC B60L 53/35; B60L 53/16; H02J 7/0042

(57) ABSTRACT

One example provides a hands free electric vehicle (EV) charging system including a charge transfer unit (CTU) to receive at least one charging power input, the CTU including a receptacle and a controllable power switch. A vehicle charging unit (VTU) is to be mounted to an underside of the EV, the VTU including a vertically controllable power cord having a plug, the power cord to electrically connect to a battery charging system of the EV, and an alignment system to adjust a horizontal position of the plug. When the VTU is positioned vertically over the CTU, the VTU is to horizontally align the plug with the receptacle and thereafter to vertically lower the power cord to place the plug in the receptacle and create an electrical connection there between, whereupon the CTU is to connect the power cord to the charging power source via the power switch.

### CROSS REFERENCE TO RELATED APPLICATIONS

This Non-Provisional Patent application claims the benefit of the filing date of U.S. Provisional Patent Application Ser. No. 63/422,684, filed Nov. 4, 2022, which is herein incorporated by reference.

### TECHNICAL FIELD

The present disclosure relates generally to examples of electric vehicles and to devices for use with an electric vehicle, including electric vehicle batteries and electric vehicle charging systems and devices.

### BACKGROUND

Electric vehicles and electric vehicle devices provide quiet, clean, and efficient powertrains for moving from place to place or for getting work done.

For these and other reasons, there is a need for the present invention.

### SUMMARY

The present disclosure provides one or more examples of an electric vehicle and systems and/or devices for use with an electric vehicle.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems.

FIG. 1 is a block and schematic diagram generally illustrating a hands free electric vehicle charging system, according to examples of the present disclosure.

FIGS. 2A-2B is a block and schematic diagram generally illustrating a hands free electric vehicle charging system, according to examples of the present disclosure.

FIG. 3 is a block and schematic diagram generally illustrating a hands free electric vehicle charging system, according to examples of the present disclosure.

FIG. 4 is a block and schematic diagram generally illustrating a residential hands free electric vehicle charging system, according to examples of the present disclosure.

FIG. 5 is a block and schematic diagram generally illustrating a hands free multi-vehicle electric vehicle charging system, according to examples of the present disclosure.

FIG. 6 is a block and schematic diagram generally illustrating portions of a hands free multi-vehicle electric vehicle charging system, according to examples of the present disclosure.

FIG. 7 is a block and schematic diagram generally illustrating portions of a hands free multi-vehicle electric vehicle charging system, according to examples of the present disclosure.

FIG. 8 is a block and schematic diagram generally illustrating portions of a hands free multi-vehicle electric vehicle charging system, according to examples of the present disclosure.

FIG. 9 is a block and schematic diagram generally illustrating portions of a hands free multi-vehicle electric vehicle charging system, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), snowmobiles, personal watercraft (PWC), all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

Handsfree Charging System Overview

The present disclosure provides a hands free EV charging system for simultaneously charging multiple EVs. One or more examples of a hands free charging system are detailed herein and illustrated in the Figures.

The hands free EV charging system may be employed in any suitable parking facility, such as parking ramps and surface parking lots, for example, and may be employed both as part of newly constructed parking facilities or adapted for use in existing parking facilities. The parking facility may be most any type of parking facility, such as a public parking facility (e.g., shopping centers), a corporate parking facility (e.g., associated with a business, such as manufacturing facility or a hotel), and a commercial parking facility (e.g., a pay facility)—any type of parking facility where EVs will be parked for extended time periods (e.g., for an hour or more) while the drivers are occupied with other tasks (e.g., shopping, dining, attending a sporting event, working, etc.). In examples, the parking facility may include parking for both EVs and non-electric vehicles.

With a hands free charging system, a vehicle owner can simply park in a charging space, request a vehicle charge via their vehicle control system or app, and walk away from the vehicle. The handsfree charging system takes it from there.

In one application, a hands free charging systeming includes a system controller, a power bus distributed across one or more charging spaces and a charging transfer unit for each charging space. A vehicle requesting a charge operation includes a vehicle charging unit. In operation, the charging transfer unit is coupled to the charging bus. The charging transfer unit transfers power from the charging bus to the vehicle battery pack (to charge the vehicle battery pack) via the vehicle charging unit. The vehicle charging unit and charging transfer unit autonomously couple to one another for hands free charging of the vehicle. In some examples, the vehicle charging unit autonomously couples to the charging transfer unit. Once charging of the vehicle battery pack is finished, the vehicle charging unit and charging transfer unit automatically disconnect from one another. The vehicle owner is notified via a charging communication such as an app, that the charging operation is complete.

The system controller, charging transfer units, vehicle charging unit, and other components of the hands free charging system are in communication with one another (as well as with EVs) using any suitable communication technique including hardwired communication and wireless communication (e.g., Bluetooth, cellular, radio, etc.).

Charging an electric vehicle is completely hands free, without the electric vehicle owner ever having to manually plug in their electric vehicle to a charging system.

Handsfree Charging System Components

The following paragraphs describe one or more examples of components of a hands free charging system.

System Controller

The system controller coordinates operation of the hands free vehicle charging system. For example, these tasks include initiation, scheduling, monitoring, and load management of vehicle charging operations. The system controller is in communication with some or all of the components of the hands free charging system. One or more examples of operation of the hands free charging system including the system controller are detailed in this specification.

Power Charging Bus

The charging bus extends across one or more charging spaces at a charging facility. In one example, the bus is located within a protected structure (e.g., a jacketed cable within a conduit, cable tray or other structure). The cable can be located in a housing (e.g., a rubber housing), and can also be located within a conduit within the rubber housing. In other applications, the power charging bus is encased in cement or safely protected in other manners. The charging bus terminates at/extends through/is coupled to a charging transfer unit located at each charging space. The charging bus receives its power from an upstream utility feed, disconnect, power panel, or other electrical system feed.

In one application the charging bus is an AC power bus. In another application, the charging bus is a DC power bus. In another application, the charging bus includes an AC and a DC power bus, where the DC power bus is used for fast charging of electric vehicles. In one case, the AC and DC power buses extend across a number of charging spaces. Then the DC power bus continues on to solely extend across a number of charging spaces that are dedicated to DC fast charging of electric vehicles. In another example, the power charging bus is an AC bus extending across multiple charging spaces. In some examples, the AC bus terminates at an AC to DC Converter, with a fast charging DC power bus then extending therefrom across a number of charging spaces beyond the converter. These charging spaces can be dedicated to fast DC charging of vehicles.

Charging Transfer Unit (CTU) A charging transfer unit is located at each charging space. The charging transfer unit is operably positioned between the vehicle charging unit and the charging bus. The charging transfer unit enables a vehicle charging unit to automatically couple to the charging bus to perform a charging operation. In one application, each charging transfer unit is centered and located near a front of each charging space for coupling to a vehicle charging unit.

Each charging transfer unit is configured to automatically couple to a vehicle charging unit. In one application a charging transfer unit includes a housing. The charging bus couples to the charging transfer unit at/within the housing. The charging transfer unit includes a smart control system, a power switch, and a vehicle connection area for automatic alignment between the vehicle charging unit and the charging transfer unit.

In one application, the vehicle connection area includes a charging and alignment pad (a charging pad) having a connection port area for connection to the vehicle charging unit via an automatic alignment system. In one example, the automatic alignment system is part of a self-aligning electromagnetic alignment system.

In another example, the charging transfer system includes a flexible, moveable connector for connecting to the vehicle charging unit. In one example, the flexible, moveable connector extends upward (e.g., electrically powered extension such as a telescopic extension) to contact the vehicle charging unit. The connector can make a mechanical type connection (e.g., a twist, prong, blade, or pressure connection) with the vehicle charging unit, or a contact connection (e.g., a magnetic or electromagnetic contact connection). A small electric motor can be used to move the connector between a stored position at the charging transfer system and an engaged, connected position at the vehicle charging unit.

Vehicle Charging Unit (VCU)

A vehicle charging unit is located on the vehicle to be charged. The vehicle charging unit is operably positioned on the vehicle for automatic coupling to the charging transfer unit, for charging of the vehicle battery pack.

In one example, the vehicle charging unit is located near the front of the vehicle, and on the underside of the vehicle (e.g., at or near the vehicle front bumper). In operation, the vehicle pulls into the charging space and the vehicle charging unit is generally positioned at or over the charging transfer unit. In one example, once positioned over the charging transfer unit, a door assembly or other access assembly opens to provide access to the charging transfer unit charging pad. In one application, during opening of the door assembly, the door assembly performs a self cleaning operation (e.g., via a cleaning bush, pad or other material) on a connection surface including the connection port area of the charging pad.

The vehicle charging unit includes a charging unit positioning system and a charging plug assembly. The charging unit positioning system operates to position the charging plug assembly over the charging transfer unit charging alignment pad. In one example, the vehicle alignment system includes an optical detection and alignment system, an electromagnetic alignment system, and/or a mechanical alignment system. Additionally, the charging unit positioning system can move (e.g., the charging plug) in a relative x, y or z direction based on the detected charging pad location, in order to align the charging plug assembly with the charging pad connection port area. The charging plug assembly includes a plug extension mechanism (e.g., a retractable system) for moving a charging plug in close proximity to the surface of the charging pad.

In one example, the charging plug assembly includes a charging plug having a magnetic coupling mechanism. Once the charging plug is brought in close proximity to the charging pad, the charging plug electromagnetically snaps into an operation position and couples to the charging pad.

In another example, the vehicle charging unit receives a connector from the charging transfer system. The vehicle charging system is moveable in multiple directions and is part of a positioning and alignment system for aligning a connector from the charging transfer system with a pad on the vehicle charging unit. The connection between the connector and the vehicle charging unit can be a mechanical, magnetic, electromagnetic, pressure or other suitable connection. In this application, the vehicle charging unit can be a very thin unit mounted to the underside of the vehicle. In one example, it is located on the underside of the vehicle at the center of the vehicle near the front bumper.

Example System Operation

System Controller/Scheduler

Upon entering the parking facility, the driver of an EV communicates with the system controller to request/schedule a battery charging operation. In one case, the driver may communicate with the system controller via an application installed on a computing device, such as a smartphone or an onboard computing device of the EV. In another case, the driver may communicate with the system controller via a scheduling station, where one or more scheduling stations may be located throughout the parking facility. Such communication may include any number of various scheduling data to enable proper and safe charging of the EV and enable the system controller to determine a charging schedule for charging operations that enables the greatest number of EVs to be charged within a given time period. In some case, such scheduling information may include a technical information, such as vehicle type (e.g., vehicle make & model), battery type, available charging options (e.g., Level 1, Level 2, DC fast charging), a current state of charge (SoC) of the EV battery, charging port type/configuration, and additional information such as a location of the EV within the parking facility (e.g., a parking space number), a license plate of the EV, a time by which the driver needs to the have the charging operation completed, driver payment information (e.g., credit card information), and driver contact information (e.g., smartphone number, email address), for example.

In examples, based on such information, the system controller determines a dynamically adjustable charging schedule for the EVs within the facility which have currently confirmed a battery charging operation. In examples, based on the information provided by the driver, and based on the current charging schedule, the system controller determines an adjusted charging schedule and communicates to the driver the expected time by which the requested charging operation will be completed and the price of the charging operation. In some examples, if more than one type of charging operation is available for the EV, in addition to the requested type of charging operation (e.g., a Level 2 charging operation), the system controller may also communicate a price and an expected completion time of an alternate charging operation type (e.g., a DC fast charging operation).

If the expected completion time and/or price of the requested (or alternate) charging operation is not satisfactory, the driver may cancel the requested charging operation and the current charging schedule is not adjusted by the system controller. In some examples, if a charging operation is not scheduled, the system controller charges the driver a fee for parking in the parking facility based on a rate schedule. If the driver accepts the charging operation (either the requested charging operation or an alternate charging operation), the system controller updates/replaces the current charging schedule with the adjusted charging schedule and provides confirmation of the estimated completion time and the price of the accepted charging operation to the driver. In some examples, the system controller may communicate status updates to the driver (e.g., scheduled times and schedule updates/adjustments, expected completion time of the charging operation, and charging operation completion, etc.).

By employing a dynamically adjustable charging schedule, the EV charging system in accordance with the present disclosure is able to charge a maximum number of EVs in a given time period while meeting the completion time of the charging operation as designated by the EV drivers. Furthermore, the EV charging system enables drivers to charge their EVs at times where the EV will otherwise be idle (e.g., while performing other activities such as working, shopping, attending a sporting event, etc.).

Example Residential Hands Free Electric Vehicle Charging System

In one application, the hands free electric vehicle charging system is used for charging a vehicle at home, garage, or smaller location. In this example, a charging transfer unit is floor mounted in a garage. The charging transfer unit can be coupled to a single charging station (e.g., wall mounted). Further, the charging transfer unit can be coupled to the single charging station through a vehicle adapter unit (for charging multiple vehicles through a single charging station) and used with a residential load management system.

A vehicle charging unit is mounted on a user's vehicle. In one example, the vehicle charging unit is mounted on the underside of the vehicle near the front bumper. Further, a vehicle stop is positioned on the garage floor. A charging control system can be located at the charging station, or everything can be located as part of the charging transfer unit.

In operation, a vehicle is parked in the garage with the front wheels positioned at the vehicle stop. In this manner, the vehicle charging unit is generally positioned over the charging transfer unit. The vehicle driver/owner can request a charge operation through the vehicle control unit, a vehicle control interface, or application (such as a cell phone app). Charging of the vehicle battery or battery pack is now performed hands free, without any other requirements from the vehicle owner. The request can be made from the vehicle, or from a user located in the residence where the user wants the vehicle charged ready to go for use at a future time.

In examples, in residential applications, the charging transfer unit includes a control unit to automatically move the vehicle charging unit and/or the charging pad in the x, y, and z directions to assist in self-alignment between the charging pad and the charging plug of the vehicle charging unit.

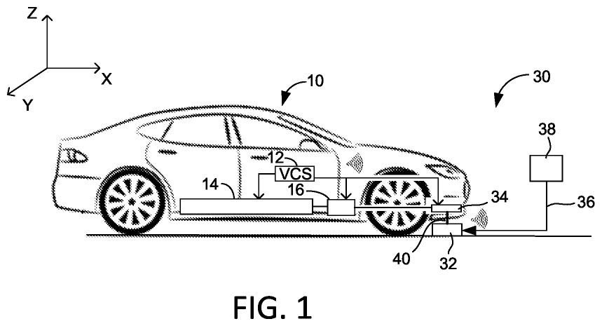

Hands Free Vehicle Charging System—FIGS. 1-9

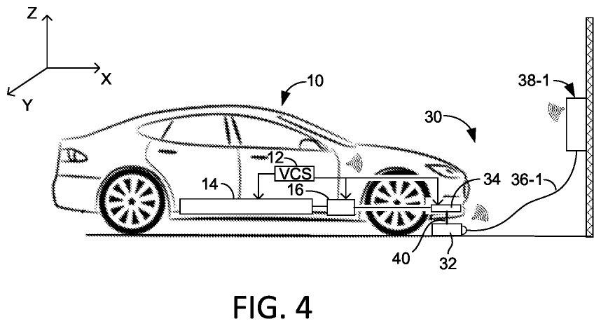

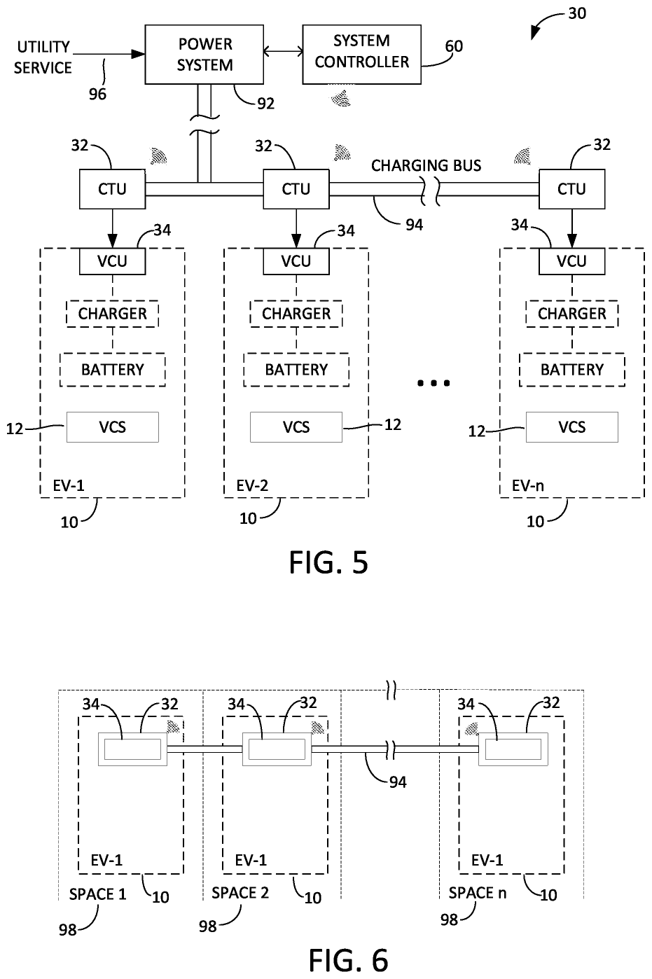

FIG. 1 is a block and schematic diagram generally illustrating a hands-free charging system 30, according to examples of the present disclosure. In one example, hands-free charging system 30 includes a charging transfer unit (CTU) 32, and a vehicle charging unit (VCU) 34 which is mounted to an electric vehicle (EV) 10, wherein EV 10 includes a vehicle control system (VCS) 12, a battery charging system 14, and a rechargeable battery 16, where VCU is coupled to battery charging system 14. In examples, CTU 32 is disposed on a surface, such as a garage floor in a residential application (e.g., see FIG. 4), or a surface of a parking lot or parking ramp (e.g., see FIGS. 5-9).

In examples, CTU 32 receives one or more charging inputs 36 from a charging power source 38, where the charging inputs 36 may be at one of a number of charging voltages (such as, for example, Level 1 (120 VAC), Level 2 (208/240 VAC, and DC (e.g., 300 VDC, 400 VDC, etc.)). In some examples, as illustrated below, hands-free charging system 30 and charging power source 38 together form portions of a multi-vehicle hands-free charging system (e.g., see FIGS. 5-9).

In operation, according to examples, as will be described in greater detail below, upon EV 10 being positioned such that VCU 34 is disposed vertically over CTU 32, a charging operation is initiated. In some examples, such charging operation may be initiated via communication between EV 10 and CTU 32 (e.g., via wireless communication between VCS 12 of EV 10 and a charge control system included as part of CTU 32). Upon initiation of a charging operation, CTU 32 and VCU 34 of EV 10 are controllably moved relative to one another in the x- and y-directions so as to be horizontally align with one another. An electrical connection 40 is then made between CTU 32 and VCU 34. In examples, as described in greater detail below, such electrical connection 40 comprises a plug and receptacle connection between CTU 32 and VCU 34 (e.g., a charging plug is lowered from VCU 34 and engages and mates with a receptacle of CTU 32).

Once electrical connection 40 is achieved there between, CTU 32 operates an internal switch to connect the charging input 36 to VCU 34 which, in-turn, connects the charging input to battery charging system 14 of EV 10 to charge battery 16. In examples, where a number of different charging inputs (each having a different charging voltage) are received by CTU 32, a selected charging voltage at which to charge EV 10 is communicated to CTU 32 as part of the charging operation information/data transmitted by VCS 12 of EV 10 to CTU 32, wherein CTU 32 operates an internal switch corresponding to the selected charging input 36.

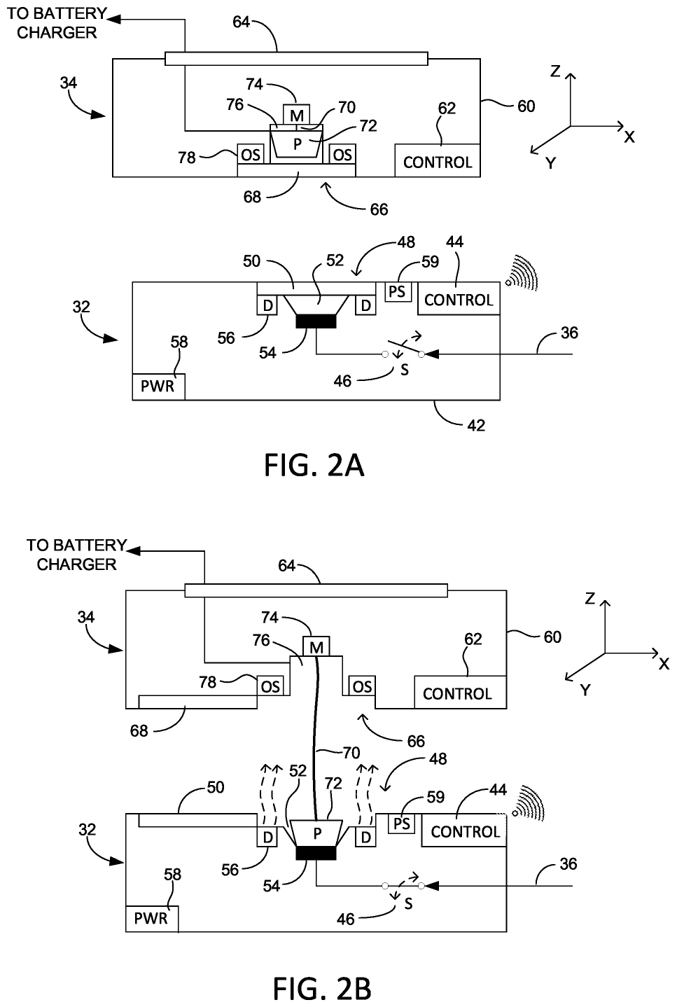

FIGS. 2A and 2B are a block and schematic diagrams generally illustrating examples of CTU 32 and VCU 34, according to the present disclosure. It is noted that for clarity and ease of illustration, EV 10 is not shown in FIG. 2. According to examples, CTU 32 includes a housing 42, a control unit 44 (e.g., a smart controller), a power switch 46, and a vehicle connection port 48. In examples, vehicle connection port 48 includes a moveable door 50 (shown in the closed position in FIG. 2A), a tapered entrance channel 52 (e.g., a truncated cone shape), a receptacle 54, and a number of LEDs 56 (or other light source, such as an infrared source, for example). In examples, CTU 32 further includes a power supply 58 for power components of CTU 32 (e.g., control unit 44 and moveable door 50), where power supply may be powered via power input 36). In examples, receptacle 54 may be a female type plug connection, a magnetic type receptacle, or any other suitable implementation. In examples, CTU 32 also includes a number of proximity sensors (PS) 59 for detecting a presence of a vehicle, such as EV 10, vertically above CTU 32.

According to examples, VCU 34 includes a housing 60, a control unit 62 (e.g., a smart controller), an alignment system 64, and a power port 66. In examples, power port 66 includes a moveable door 68, power cord 70 having a plug 72, a motor 74 to control extension and retraction of power cord from a storage cavity 76, and a number of optical sensors (OS) 78. In examples, alignment system 64 adjusts a horizontal position (x- and y-directions) power cord/plug 70/72 (such as via control of the horizontal position of housing 60).

With reference to FIG. 2B, in operation, according to one example, when EV 10 drives over and positions VCU 34 above CTU 32, proximity sensor(s) 59 detect the presence of EV 10. Upon proximity sensor(s) 59 detecting the presence of EV 10, control unit 44 of CTU 32 communicates with vehicle control system 12 of EV 10 (see FIG. 1) to determine whether a charging operation is to be initiated. In some examples, control unit 44 initiates a charging each time the presence of EV 10 is sensed by proximity sensor(s) 59. Upon initiation of a charging operation, control unit 44 opens moveable door 50 and LEDs 56 begin emitting light. Similarly, control unit 62 of VCU 34 is notified by vehicle control system 12 that a charging operation has been initiated and, in response, opens moveable door 68 and activates optical sensors 78. Based on the amount of light from LEDs 56 sensed by optical sensor(s) 78, control unit 62 adjusts the horizontal position (x- and y-directions) of power cord/plug 70/72 so as to be aligned with receptacle 54 of CTU 32.

Once aligned, control unit 62 operates motor 74 to lower power cord/plug 70/72 toward receptacle 54 of CTU 32. As plug 72 is lowered, tapered entrance channel guides plug 72 to receptacle 54 where an electrical connection is made between power cord/plug 70/72 and receptacle 54. In some examples, plug 72 is magnetically aligned and secured to receptacle 54. In some examples, a cam mechanism at receptacle 54 is operated, which engages plug 72 and pulls plug 72 into receptacle 54. In some examples, the connection represents a standard J1772 configuration. In other examples, any suitable connection may be made between plug 72 and receptacle 54, including surface mounted contacts which are biased against one another (e.g., mechanically and/or magnetically biased). Once an electrical connection is made between plug 72 and receptacle 54, control unit 44 operates power switch 46 to connect receptacle 54 to charging power input 36, which in-turn, connected battery charging system 14 of EV 10 (see FIG. 1) to charging power input 36 via power cord/plug 70/72.

Once the charging operation is completed (e.g., when battery 16 has reached a desired charge level or EV 10 is going to be driven), power switch 46 is opened, plug 72 is released from receptacle 54, power cord 70 and plug 72 are retracted into cavity 76 by motor 74, and moveable doors 50 and 68 are returned to their closed positions (as illustrated in FIG. 2A).

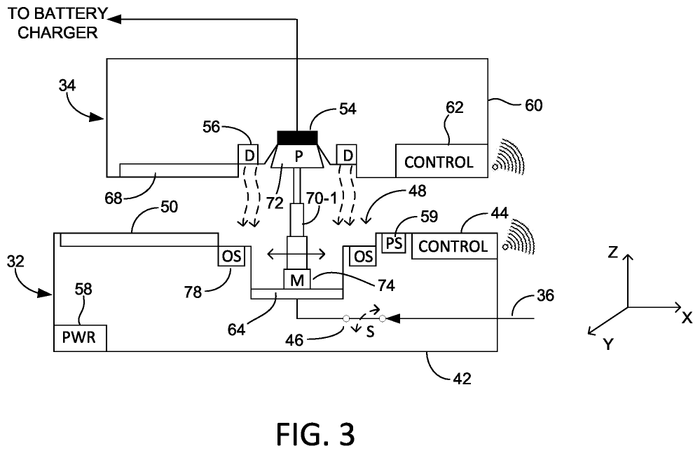

FIG. 3 is a block and schematic diagram generally illustrating and example of CTU 32 and VCU 34, according to the present disclosure. In contrast to the examples of FIGS. 2A and 2B, in the example implementation of FIG. 3, horizontal alignment system 64, power cord/plug 70/72, motor 74, and optical sensors 78 are included as part of CTU 32, while receptacle 54 and LEDs 56 are included as part of VCU 34. Additionally, in the example of FIG. 3, power cord 70 is implemented as a telescoping arm 70-1 that can be extended and retracted from CTU 32 by motor 74.

An alignment and charging operation of CTU 32 and VCU 34 according to the example implementation of FIG. 3 is similar to that of FIGS. 2A and 2B, except that horizontal alignment of plug 72 of VTU 32 with receptacle 54 of VCU 34 is carried out via controlled movement of telescoping arm 70-1 in the x- and y-directions by control unit 44 based on light received from LEDs 56 by optical sensors 78.

FIG. 4 is a block and schematic diagram where hands-free charging system 30 is implemented in a residential environment, such as a residential garage, where charging power source 38 is an EV charging station 38-1, and where charging power input 36 comprises a power cord 36-1 from EV charging station 38-1 which is plugged into a receptacle on CTU 32.

FIGS. 5-9 are block and schematic diagrams generally illustrating a hands-free charging system 30, or portions of hands-free charging system 30, implemented for simultaneous hands-free charging of multiple EVs 10. In examples, multi-vehicle hands-free charging system 30 of FIGS. 5-9 may be employed in any suitable parking facility, such as parking ramps and surface parking lots, for example, and may be implemented as part of newly constructed parking facilities or adapted for use in existing parking facilities. The parking facility may be any type of parking facility, such as a public parking facility (e.g., shopping centers), corporate parking facilities (e.g., associated with a business, such as a manufacturing facility or a hotel), and commercial parking facilities (e.g., a pay facility)—any type of parking facility where EVs will be parked for extended time periods (e.g., an hour or more) while the drivers are occupied with other tasks (e.g., shopping, dining, attending a sporting event, working, etc.). In examples, the parking facility may include parking for both EVs and non-electric vehicles.

FIG. 5 is a block and schematic diagram generally illustrating multi-vehicle hands-free charging system 30, according to one example. System 30 includes a system controller 90, and a power system 30 providing one or more charging power outputs 36, wherein the one or more charging power outputs are implemented as a charging bus 94. In one example, power system 30 is fed by a utility power feed 96 and provides one or more charging power outputs via charging bus 94, where such charging outputs may be AC and/or DC charging power outputs (e.g., Level 1 (120 VAC), Level 2 (208/240 VAC), and DC (e.g., 200, 300, 400, etc., any suitable DC voltage and power level).

With further reference to FIG. 6, in examples, charging bus 94 extends across multiple EV charging/parking spaces 98, with each parking space 98 having a corresponding VTU 32 associated therewith which is electrically connected to charging bus 94. In some examples, charging bus 94 may be surface mounted on the floor of a parking ramp or a surface of an outdoor surface parking lot. In some examples, charging bus 94 may be suspended from a ceiling of a parking ramp, or suspended from a support structure extending along and over parking spaces of an outdoor surface parking lot. In other examples, charging bus 94 may disposed below ground. With reference to FIG. 6, according to one example, when an EV 10 is parked within a parking space, the VCU 34 of the vehicle is positioned above the corresponding CTU 32 and an alignment and charging operation is carried out, as described above with respect to FIGS. 1-3, for example.

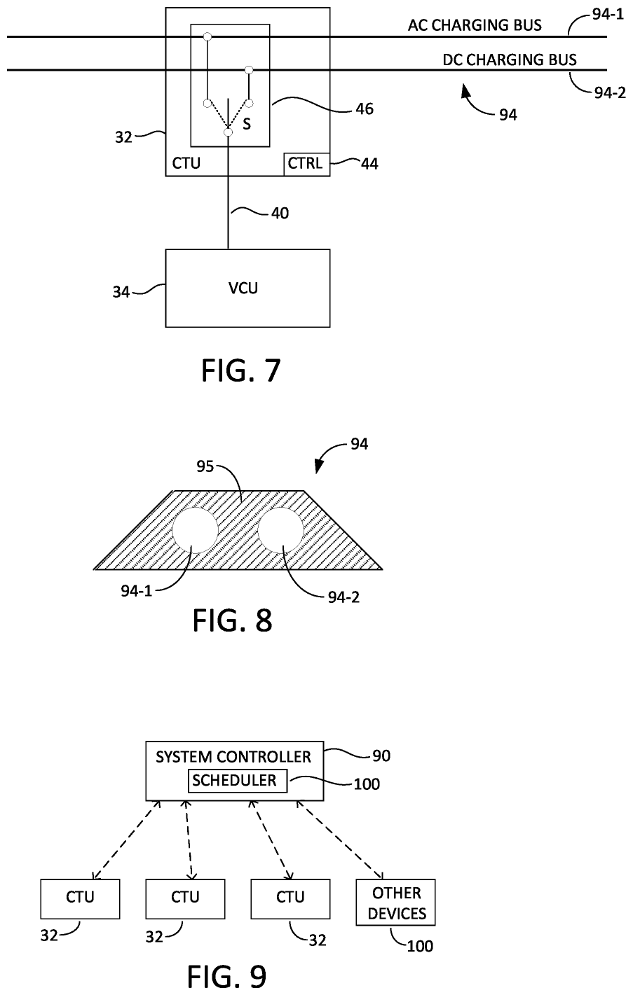

With reference to FIG. 7, according to one example, charging bus 94 includes both an AC charging bus 94-1 and a DC charging bus 94-2 having corresponding voltage and power levels. Although illustrated as having one AC charging bus 94-1 and one DC charging bus 94-2, in other examples, charging bus 94 may have more than one AC charging bus and more than one DC charging bus, with each bus having a corresponding voltage and power level. With reference to FIG. 7, according to one example, power switch 46 comprises a selector switch that is electrically connected to both the AC charging bus 94-1 and to the DC charging bus 94-2. In one example, as part of the charging operation, the corresponding EV 10, via communications between vehicle control system 12 (see FIGS. 1 and 5) and control unit 44 of the corresponding CTU 32 and/or system controller 90, indicates which of the available charging power outputs which are available on charging bus 94. After the VCU 34 of the EV 10 is electrically connected to the corresponding CTU 32, the control unit 44 operates the power switch 46 to connect to the selected charging power output. With reference to FIG. 7, power switch 46 is able to connect to either the AC charging bus 94-1 or to the DC charging bus 94-2, whichever is selected for a charging operation by EV 10.

FIG. 8 is a schematic diagram generally illustrating charging bus 94 implemented as a surface mounted bus 94 having AC charging bus 94-1 and DC charging bus 94-1 encased within a weather- and impact-resistant housing 95 which is able to withstand impacts of vehicles driving there over.

FIG. 9 is a schematic diagram that, in one example, system controller 90 is in communication with each CTU 32, as well as with any other devices 102 (e.g., a pay station), where such communication may be any suitable wireless or wired communication protocol. In one example, system controller 90 includes a load scheduler 100 which manages simultaneous charging of the multiple EVs 10.

In operation, according to examples, upon entering the parking facility, the driver of an EV 10 communicates with the system controller 90 to request/schedule a battery charging operation. In one case, the driver may communicate with the system controller 90 via an application installed on a computing device, such as a smartphone or an onboard computing device of the EV (e.g., vehicle control system 12). In another case, the driver may communicate with the system controller 90 via a scheduling station, where one or more scheduling stations may be located throughout the parking facility. Such communication may include any number of various scheduling data to enable proper and safe charging of the EV 10 and enable the system controller 90 to determine a charging schedule for charging operations that enables the greatest number of EVs to be charged within a given time period. In some case, such scheduling information may include a technical information, such as vehicle type (e.g., vehicle make & model), battery type, available charging options (e.g., Level 1, Level 2, DC fast charging), a current state of charge (SoC) of the EV battery 16, charging port type/configuration, and additional information such as a location of the EV within the parking facility (e.g., a parking space number), a license plate of the EV, a time by which the driver needs to the have the charging operation completed, driver payment information (e.g., credit card information), and driver contact information (e.g., smartphone number, email address), for example.

In examples, based on such information, the system controller 90 determines a dynamically adjustable charging schedule 100 for the EVs within the facility which have currently confirmed a battery charging operation. In examples, based on the information provided by the driver, and based on the current charging schedule 100, the system controller 90 determines an adjusted charging schedule 100 and communicates to the driver the expected time by which the requested charging operation will be completed and the price of the charging operation. In some examples, if more than one type of charging operation is available for the EV 10, in addition to the requested type of charging operation (e.g., a Level 2 charging operation), the system controller 90 may also communicate a price and an expected completion time of an alternate charging operation type (e.g., a DC fast charging operation).

If the expected completion time and/or price of the requested (or alternate) charging operation is not satisfactory, the driver may cancel the requested charging operation and the current charging schedule is not adjusted by the system controller 90. In some examples, if a charging operation is not scheduled, the system controller 90 charges the driver a fee for parking in the parking facility based on a rate schedule. If the driver accepts the charging operation (either the requested charging operation or an alternate charging operation), the system controller 90 updates/replaces the current charging schedule 100 with the adjusted charging schedule and provides confirmation of the estimated completion time and the price of the accepted charging operation to the driver. In some examples, the system controller 90 may communicate status updates to the driver (e.g., scheduled times and schedule updates/adjustments, expected completion time of the charging operation, and charging operation completion, etc.).

By employing a dynamically adjustable charging schedule 100, the EV charging system in accordance with the present disclosure is able to charge a maximum number of EVs in a given time period without overloading power system 92 and charging bus 94 while meeting the completion time of the charging operation as designated by the EV drivers. Furthermore, the hands-free EV charging system 30 enables drivers to charge their EVs at times where the EV will otherwise be idle (e.g., while performing other activities such as working, shopping, attending a sporting event, etc.).

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. (canceled)

2. A charge transfer unit for hands-free charging of an electric vehicle (EV), comprising:
a housing to be disposed on a surface of an EV parking space;
an alignment system moveable at least horizontally;
an EV connector disposed on the alignment system;
a power switch controllable to connect the charge transfer unit to at least one charging power source; and
a controller, upon receiving a charging request from the EV, the controller to:
adjust a horizontal position of alignment system to horizontally align the EV connector with a charging port connector on the EV;
vertically connect the EV connector to the charging port connector; and
upon connecting the EV connector to the charging port connector, close the power switch to connect to a selected one of the least one charging power source to the EV to charge the EV.

3. The charge transfer unit of claim 2, the controller to vertically adjust a position of the alignment system to vertically connect to the EV connector to the charging port connector.

4. The charge transfer unit of claim 3, wherein the alignment system includes a telescoping arm which is vertically extendable and retractable to vertically connect and disconnect the EV connector from the charging port connector of the EV.

5. The charge transfer unit of claim 3, the controller to receive the charging port connector as extended from the EV to vertically connect the EV connector to the charging port connector.

6. The charge transfer unit of claim 2, wherein the EV connector and charging port connector comprise an electrical plug and electrical receptacle type connection.

7. The charge transfer unit of claim 2, including a plurality of position sensors to determine locations of one or more indicating devices indicative of a location of the EV charging port connector, the controller to adjust the horizontal position of the alignment system based on outputs from the position sensors.

8. The charge transfer unit of claim 2, including a plurality of proximity sensors to determine the presence of an EV when disposed over the charge transfer unit.

9. The charge transfer unit of claim 2, wherein the power switch is controllable to connect the charge transfer unit to a plurality of charging power sources, each charging power source having different electrical parameters, wherein the controller controls the power switch to connect to a selected one of the plurality of charging power sources as indicated by the charging request.

10. The charge transfer unit of claim 2, wherein the controller communicates with the EV via a wireless connection.

11. The charge transfer unit of claim 2, wherein horizontal is defines as being x- and y-directions parallel to the surface of the EV parking space, and vertical is defined as being a z-direction perpendicular to the surface of the EV parking space.

12. A hands-free electric vehicle (EV) charging system comprising:
a vehicle charging unit to be mounted to an EV, the vehicle charging unit including:
a charging port connector; and
at least one position indicating device; and
a charge transfer unit to be disposed on a surface of an EV parking location, the charge transfer unit including:
an EV connector;
an alignment system controllable to adjust at least a horizontal position of the EV connector;
at least one proximity sensor;
at least one position sensor;
a power switch controllable to connect the charge transfer unit to at least one charging power source and
a controller, upon detecting the presence of the EV disposed above the charge transfer unit via the proximity detector, the controller to:
establish wireless communication with the EV and, upon receiving a charging request from the EV to:
adjust the horizontal position of the EV connector to horizontally align with the charging port connector of the vehicle charging unit via horizontal movement of the alignment system based on detection of the at least one position indicating device by the at least one position sensor;
vertically connect the EV connector to the charging port connector; and
upon connecting the EV connector to the charging port connector, close the power switch to connect to a selected one of the least one charging power source to the EV to charge the EV.

13. The hands-free electric vehicle charging system of claim 12, the controller to vertically adjust a position of the alignment system to vertically connect to the EV connector to the charging port connector.

14. The hands-free electric vehicle charging system of claim 13, wherein the alignment system includes a telescoping arm which is vertically extendable and retractable to vertically connect and disconnect the EV connector from the charging port connector of the EV.

15. The hands-free electric vehicle charging system of claim 12, the controller to receive the charging port connector as extended from the EV to vertically connect the EV connector to the charging port connector.

16. The hands-free electric vehicle charging system of claim 15, wherein the charging port connector is moveable back and forth vertically to connect and disconnect to the EV connector.

17. The hands-free electric vehicle charging system of claim 12, wherein the EV connector and charging port connector comprise an electrical plug and electrical receptacle type connection.

18. The hands-free electric vehicle charging system of claim 12, wherein the charge transfer unit includes a door operable between a closed position, where the EV connector is protected from an exterior environment, and an open position, where the EV connector is exposed to the exterior environment, and wherein the door includes a cleaning element to clean the EV connector each time the door is opened and closed.
